(19) United States
(12) Patent Application Publication
(10) Pub. No.: US 2014/0248575 A1
(43) Pub. Date: Sep. 4, 2014

(54) DENTAL APPARATUS FOR TREATING MALOCCLUSION

(71) Applicant: ORTHODONTIE ALLIANCE LABORATOIRE, Aix-en-Provence (FR)

(72) Inventor: Renaud Desouches, Aix-en-Provence (FR)

(21) Appl. No.: 14/348,999

(22) PCT Filed: Oct. 22, 2012
(86) PCT No.: PCT/FR2012/052414

§ 371 Date: Apr. 1, 2014

(30) Foreign Application Priority Data
Oct. 28, 2011 (FR) 1159803

(51) Int. Cl. A61C 7/36

(52) U.S. Cl. CPC A61C 7/36
USPC 433/19

(57) ABSTRACT

Device for activating mandibular growth, maxillary growth and mandibular advancement, the device having a first rod with a front end and a rear end; a second rod with a front end and a rear end; the first and second rods having mutually different lengths; a first pivoting articulation for connecting the front end of the first rod to a first dental arch of a person; a second pivoting articulation for connecting the front end of the second rod to the second dental arch of the person; a third pivoting articulation interconnecting the rear ends of the rods, the third pivoting articulation being connected to the dental arch carrying the shortest rod with the aid of elastic means returning the device to the closed position.

### TECHNICAL FIELD OF THE INVENTION

The invention relates to the field of corrective devices for dentofacial misalignments, and relates more specifically to a device used in an orthodontic treatment for repositioning of the mandibular arch with respect to the maxillary arch in order to correct Class II and Class III defects for children and adolescents and thus improve dental occlusion. A corrective device according to the invention is intended to enable the activation of mandibular growth, the activation of maxillary growth, as well as nocturnal mandibular advancement to provide protection against sleep apnea.

### PRIOR ART

Childhood maxillofacial growth dysmorphosia can lead to maxillary or mandibular prognathism or retrognathism. This dysmorphia can be corrected by the use of apparatuses or devices called growth activators, which exert controlled stress on the mandible and which the child wears for at least some of the day, during the maxillofacial growth phase.

More specifically, mandibular growth activators are apparatuses that promote growth of the mandible by forced advancement; maxillary growth activators are apparatuses promoting maxillary growth by forced retraction of the mandible.

These apparatuses can be one-piece, such as the Balters bionator, or two-piece.

Different types of mandibular growth activators are known. For example, a class II Lautrou activator is known, which consists of a one-piece device fenestrated in the palate-incisor region, associated with headgear. An activator called a Herbst rod is also known. A system called Liberty Rod and a device called Herbst Flip Lock, which can be produced on pedodontic rings or caps, are also known.

Frankel and Balter activators are also known.

Such activators are described in patent applications FR 2 702 141 (Henri Petit), WO 2004/026163 (Orthotain, Inc.), WO 86/04806 (Marcel Korn), EP 0 128 744-A2 (Farel A. Rosenberg), EP 1 108 397-A1 (Ortho Organizers), WO 96/41584 (Kussick Orthopedic Systems, LLC) and WO 2004/064662 (Orthotain Inc.).

These activators have various disadvantages. Thus, certain activators are difficult to wear because they are relatively large and are visible, having parts located outside the oral cavity, and, moreover, they limit the opening of the mouth. In other activators, forces applied anteriorly cause buccoversion of the lower incisors or linguoverison of the upper incisors.

Advancement-type devices are also known, which enable the pharyngeal passage to be cleared by advancement of the mandible. These devices are used to treat sleep apnea. They are described in patent applications WO 2007/010332 (S. Schmidt and C. Scheeck), WO 95/14449 (N. Ingemarsson), WO 2007/146523 (RIC Investments, LLC), WO 2009/158424 (Bryan Keropian), WO 2008/048649 (S. Katz and P. Strong), FR 2 887 140 (Laurent Faucher), WO 2005/082452 (I. Sanders), WO 01/52928 (Respironics, Inc.), WO 2009/096889 (Gellerfors), EP 1 602 347-A1 (Georges Magnin), WO 94/23673 (Leonard Halstrom), WO 2006/058514 (Winfried Toussaint), WO 2005/000142 (Bryan Keropian), WO 2007/136551 (Bryan Keropian), EP 1 203 570-A2 (Winfried Toussaint), WO 01/45604 (Peter L′Estrange et al.), WO 2006/125216 (John D. Summer), WO 2005/074480 (Massachusetts General Hospital), FR 2 816 203 (Bernard Fleury et al.), and in patents U.S. Pat. No. 5,427,117 and U.S. Pat. No. 5,566,683 (W. Thornton), EP 0 845 962-B1 (M. David et al.) relating to a product sold under the trade name SNORFLEX, and FR 2 831 427 B1 (Ph. Mousselon and L. Baratier), relating to a product sold under the trade name NARVAL.

Some of these orthoses are sold in one size. Others are customized after obtaining impressions. They all have the disadvantage of limiting the opening of the mouth or of not enabling it at all. In some cases, when forces are applied anteriorly, they can cause buccoversion of the lower incisors.

In addition, orthodontic devices are known which comprise rods pivotably mounted with respect to one another and fastened to the teeth or to the dental arches by pivoting joints or by swivel joints.

Document U.S. Pat. No. 4,382,783 describes such an orthodontic device for the treatment of a Class II defect comprising two rigid arms connected to one another, at one end by a pivoting hinge, and the other end being mounted by a hinge-type link to an upper molar, and to a lower molar, respectively. In one alternative, a torsion spring is mounted around the central joint in order to bring the two arms together. While this admittedly enables greater opening of the oral cavity than the devices described above, this device nevertheless has the disadvantage of using a posterior anchoring, in particular on the upper and lower molars, which anchoring, combined with a rotation action of the two arms around the central hinge, causes tensile force to be applied on the two arches, which reduces the efficacy of the treatment. Moreover, the closing of the device around a hinge freely suspended between the two arches carries the risk of causing it to move in the internal membrane of the cheeks, and, therefore, of being irritating during use.

Document WO 99/53859 describes another orthodontic device comprising two rigid arms pivotably connected to one another around a central hinge and each mounted pivotably with respect to anchoring points of the upper and lower dental arches. Thus, a first arm is caused to pivot around a first anchoring point located on a molar in the upper dental arch, and the second arm is caused to pivot around a second anchoring point located on a cuspid in the lower dental arch. In one alternative, a compression spring is arranged along the lower arm to return the opening of the oral cavity. While it admittedly ensures better positioning of each rigid arm, and therefore of the application of force with respect to the dental arches, this device has the disadvantage of holding the mouth in the open position, which is uncomfortable, while being ineffective, because it is known that optimal efficacy is achieved when the oral cavity is in the closed position.

The objective of this invention is to at least partially overcome these disadvantages and to propose a device for activating mandibular growth, maxillary growth and mandibular advancement that enables the mandible to be moved with respect to the maxilla during occlusion in order to obtain effective repositioning of the mandibular arch with respect to the maxillary arch, while allowing proper opening of the oral cavity.

Another objective of the invention is to propose a device for activating mandibular growth, maxillary growth and mandibular advancement that is comfortable to wear while ensuring sufficient movement in order to enable growth defects of the upper and lower dental arches to be corrected.

Another objective of the invention is to propose a device for activating mandibular growth, maxillary growth and mandibular advancement that is capable of applying the forces necessary for treatment in a constant and sustainable manner over time.

Another objective of the invention is to propose a device for activating mandibular growth, maxillary growth and mandibular advancement that can easily be adapted to the person undergoing treatment, while having a simplified design and being capable of being inexpensively mass produced.

### Subject Matter

According to the invention, the problems are solved by a device for activating mandibular growth, maxillary growth and mandibular advancement comprising:

a first rod comprising a front end and a rear end;

a second rod comprising a front end and a rear end;

said first and second rods being relatively rigid and having different lengths with respect to one another;

a first pivoting joint capable of connecting the front end of the first rod to a first dental arch of a person (i.e. to the maxillary arch or to the mandibular arch);

a second pivoting joint capable of connecting the front end of the second rod to a second dental arch of the person (i.e. to the mandibular arch or to the maxillary arch);

a third pivoting joint connecting the rear ends of the rods to one another enabling the device to go from an open position, also called an “opening position” to a closed position, also called a “closing position”, and thus to follow the movement of opening and closing of the jaws,

because said third pivoting joint is connected to the dental arch supporting the shortest rod with elastic means for returning the device to the closed position so that said rods are capable of causing a relative movement of the mandibular arch with respect to the maxillary arch in the closed position of the jaws.

Thus, the device of the invention includes substantially rigid rods, having different lengths, which are each connected by a pivoting joint or hinge to one of the dental arches and which are connected to one another by a third pivoting joint or hinge. By front end, we mean the mesial end of a rod, and by rear end, we mean the distal end of the rod. These first and second rods can be arranged on only one side of the oral cavity, but it is preferable to arrange two sets of such rods, one on each side of the oral cavity, on the exterior side of the dental arches. This already makes it possible to ensure a good opening of the oral cavity during the treatment performed with the device.

More specifically according to the invention, the third pivoting joint is connected to the dental arch supporting the shortest rod by elastic means for returning the device to the closed position. The pivoting joint is thus connected to the dental arch, which pivotably supports the shortest rod, at the same level as the supporting point of the shortest rod or retracted rod (in the posterior portion) thereof. This makes it possible to ensure the forced anterior-posterior movement of the mandible with respect to the maxilla during occlusion for optimal efficacy of the treatment. In addition, as the third joint of the device remains near the jaw supporting the shortest rod, the amplitude of the opening movement is determined by the length thereof, which enables the device to be comfortable to wear and therefore any irritation caused by the movement from the open position to the closed position to be avoided.

Preferably, the pivot axis of the first pivoting joint is located near a cuspid of a dental arch, the pivot axis of the second pivoting joint is located near a first molar of the opposite dental arch and the pivot axis of said third pivoting joint is located in an occlusal plane in the closed position of the jaws.

Thus, in the case of a device intended for treating a Class II defect, the device of the invention has a first rod or longest rod or upper rod that has an anterior attachment at the cuspid for the upper maxilla and a second rod or shorter rod that has a posterior attachment at the first lower molar. The length of the upper rod will be greater than that of the lower rod so as to enable advancement of the mandible. A spring connecting the hinge pin between the two rods and the mandibular support forces the occlusion in the anterior position. The major physiological advantage of this apparatus is the point of posterior application of force at the mandible, which limits buccoversion of the lower incisors. The same technique will be used for nocturnal mandibular advancements in the context of sleep apnea.

In the case of a device intended for the treatment of a Class III defect promoting mandibular retraction, the device of the invention has a first rod or longer rod or lower rod having an anterior attachment at the cuspid for the mandible and a second rod or shorter rod that has a posterior attachment at the first upper molar. The length of the lower rod is greater than that of the upper rod so as to enable retraction of the mandible. A spring connecting the hinge pin between the two rods and the maxillary tray forces the occlusion in the posterior position. The major physiological advantage of this apparatus is the posterior point of application of the force at the maxilla, which limits buccoversion of the upper incisors.

The three pivot axes are parallel to one another and parallel to the pivot axis of the mandible, which ensures a natural opening and closing movement of the jaws.

Advantageously, the second rod is shorter and has a length substantially equal to the amplitude of opening of the oral cavity measured in the location where it is placed.

This shorter rod performs a pivoting movement from an inclined position, in the closed position of the jaws, to a substantially vertical position, when the jaws are opened, which defines the amplitude of movement and the course of the elastic return means.

Preferably, the movement of the mandibular arch with respect to the maxillary arch occurs in a substantially horizontal plane in the closed position of the device.

The three pivoting joints are arranged so that, in the closed position of the jaws, the first and the second joints are arranged substantially in the same plane. This enables movement of the arches one with respect to the other in the closed position of the jaws and in an occlusal plane, which further improves the efficacy of the treatment performed with the device of the invention.

Advantageously the ratio of the lengths of the two rods is between 0.3 and 0.5. After numerous tests performed in the laboratory, it was noted that this ratio enabled an effective treatment and optimal opening of the oral cavity to be obtained. Indeed, the longest rod has a substantially horizontal movement during the change from the open position of the device while the shortest rod has a substantially vertical movement.

Preferably, the length of at least one of said rods can be adjusted.

In a treatment of a class II defect, the length of the upper rod is preferably adjustable so as to enable a progressive correction of the mandibular growth. Different adjustments of the two upper rods make it possible to adjust asymmetries in mandibular growth.

In a treatment of a class III defect, the length of the lower rod is preferably adjustable so as to enable a progressive correction of the maxillary growth and slowing of the mandibular growth. Different adjustments of the two upper rods make it possible to adjust asymmetries in mandibular growth.

The growth of the maxilla can be potentiated by adding headgear (Delaire); the point of application of the force is advantageously located on the anterior portion of the maxillary tray (between the lateral incisor and the cuspid).

Advantageously, said elastic means include a tension spring. Elastics such as elastomer elastics could have been chosen for connecting the third pivoting joint to the dental arch. It is preferable, however, to use a tension spring for its properties of mechanical robustness and consistency of force applied throughout the period of use of the device.

Preferably, the device of the invention includes means for adjusting the force of said spring. This makes it possible to adapt the return force to the sensitivity of each person.

The objectives of the invention are also achieved with a dental apparatus comprising an upper tray capable of being attached to the maxillary arch, a lower tray capable of being attached to the mandibular arch and a device according to the invention connected by the first rod to said upper tray and by the second rod to said lower tray.

Such a dental apparatus includes two trays and a device of the invention pivotably mounted on the trays. This makes it possible to ensure a good attachment to the dental arches, while offering the possibility of easily removing the apparatus from the oral cavity. Such an apparatus is more specifically suitable for children who do not yet have permanent dentition.

Advantageously, at least one of the upper or lower trays of the dental apparatus of the invention contains a filling material, preferably at least one liquid, semi-liquid or gelatinous polymer and has one or more vent holes passing through its walls and produced so as to enable the expansion of the tray and the adaptation of the tray to the size of the dental arch that it surrounds after having received said filling material.

This makes it possible to more precisely adapt the dental apparatus of the invention to the configuration of the jaws of the person using it.

### DESCRIPTION OF THE FIGURES

FIG. 1a schematically shows the closed position of the jaws of a person having a class II Angle defect, and FIGS. 1b and 1c show the placement of a device of the invention in the open position and the closed position, respectively.

FIG. 2a schematically shows the closed position of the jaws of a person having a class III Angle defect, and FIGS. 2b and 2c show the placement of a device of the invention in the open position and the closed position, respectively.

FIGS. 3a and 3b schematically show a first embodiment of the device of the invention, in the open position, used to treat class III and class II Angle defects, respectively.

FIGS. 4a and 4b schematically show a second embodiment of the device of the invention, in the open position, used to treat class III and class II Angle defects, respectively.

FIGS. 5a and 5b show different embodiments of a short rod of the device of the invention.

FIG. 6 shows an embodiment of a long rod of the device of the invention.

FIGS. 7a to 7c show different steps for producing trays used with the device of the invention.

### LIST OF REFERENCE NUMBERS

| | |
|---|---|
| 1 | First tray |
| 2 | Second tray |
| 3 | First rod |
| 4 | Second rod |
| 5 | Elastic means |
| 6 | First hinge |
| 7 | Third hinge |
| 8 | Second hinge |
| 9 | Front end of the first rod |
| 10 | Rear end of the first rod |
| 11 | Front end of the second rod |
| 12 | Rear end of the second rod |
| 14 | Tension spring |
| 15 | Device for activating maxillary or mandibular |
| | growth and mandibular advancement |
| 16 | Short rod sleeve |
| 17 | Short rod slide |
| 18 | Slide head |
| 19 | Joint orifice |
| 20 | Joint orifice |
| 21 | Tab |
| 22 | Drill holes |
| 23 | Long rod sheath |
| 24 | Drill holes |
| 25 | Screw |
| 26 | Joint orifice |
| 27 | Joint orifice |
| 28 | First spring end |
| 29 | Second spring end |
| 30 | Thermoformed sheet |
| 31 | Polymer gel |
| 32 | Vent hole |

### DETAILED DESCRIPTION

The device 15 according to a preferred embodiment of the invention and as shown in the appended figures includes a first and a second tray 1, 2, each made so as to be capable of being arranged around a dental arch, the trays being planar on the occlusal faces. Each tray has a general U shape, the trays 1, 2 being connected on each side by first and second pivotably connected rods 3, 4 by three pivoting joints or hinges 6, 7, 8 with parallel axes and parallel to the pivot axis of the mandible. The device also includes elastic return means 5 connecting it to one of the dental arches, as will be explained below. More specifically, a first tray 1 is connected on each side to a second tray 2 by means of a device 15 by means for attaching the trays to a first rod 3 and to a second rod 4 of the device. Each rod 3, 4 is attached to a tray 1, 2 by a first and a second joint 6, 8 called peripheral joints. More specifically, the first rod 3 is connected by a first hinge 6 to the first tray 1 and the second rod 4 is connected by a second hinge 8 to the second tray 2. The first and second rods 3, 4 are connected to one another by a third hinge 7 or central hinge. Elastic return means 5, for example a spring or an elastic made of rubber or elastomer, connects the central hinge 7 to the tray supporting the shortest rod 4.

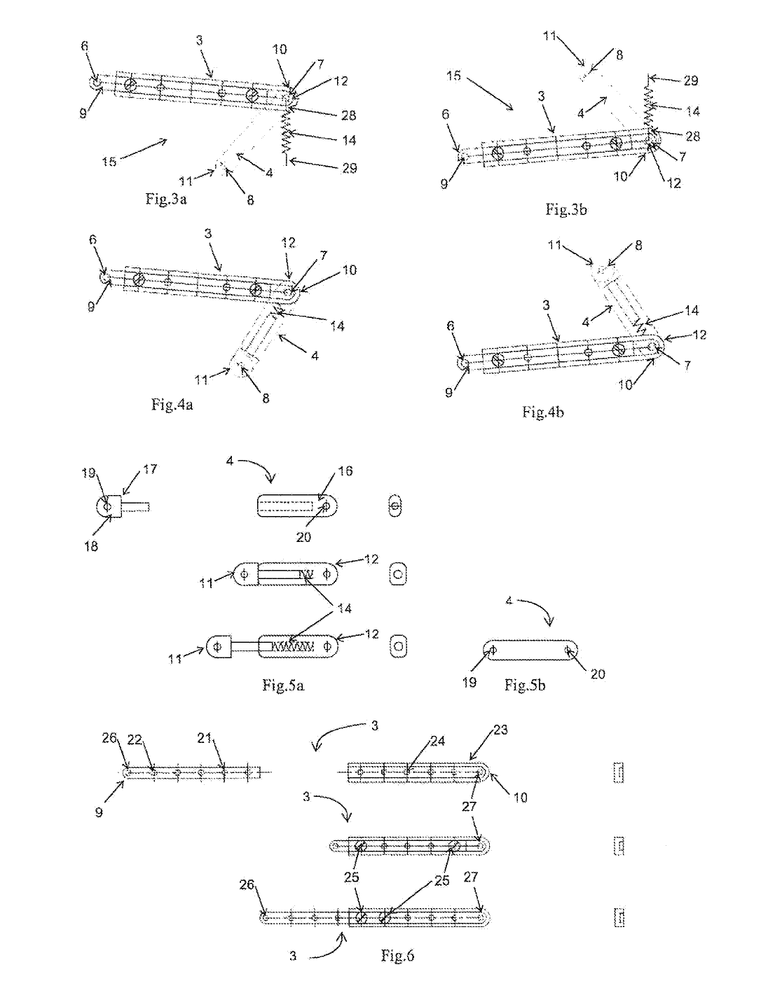

In a first embodiment, as can better be seen in FIGS. 3a and 3b, the elastic means can be a tension spring 14 connecting the central joint pin 7 and attachment means located at the dental arch or the tray. The first rod 3 is advantageously longer than the second rod 4. The tension spring 14 comprises a first end 28 connected to the central joint pin 7 and a second end 29 that is intended to be connected behind the first molar, for example consisting of an anchoring located at the second molar.

In a second embodiment, as can better be seen in FIGS. 4a and 4b, the elastic means 5 can be a tension spring 14 arranged along the second rod 4, which spring connects the central joint pin 7 and the end of the slide 17 of the rod 4 as will be explained below.

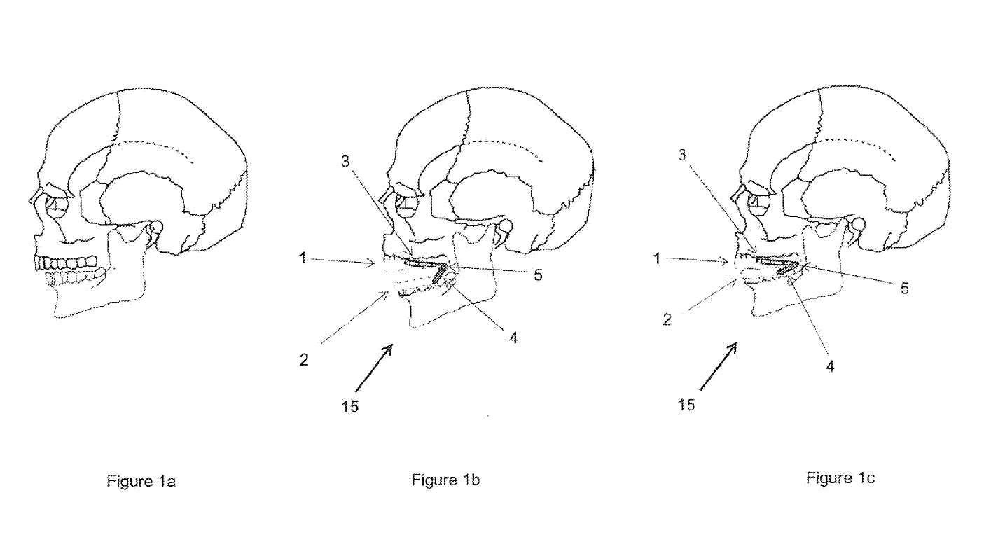

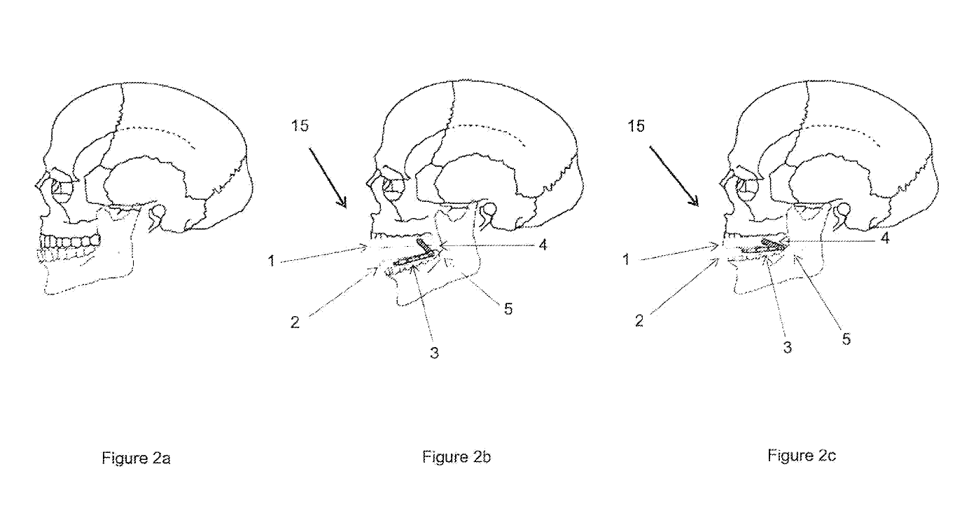

In a first embodiment of the device 15 of the invention, and as shown in FIGS. 3a and 4a, the device of the invention is used to correct class II Angle defects or to cause nocturnal mandibular advancement in the context of sleep apnea. As can better be seen in FIGS. 1 and 2, the hinges 6, 7, 8 are attached close to the respective ends 9, 10, 11, 12 of the rods 3, 4. The second hinge 8 is located close to the end of the second tray 1, i.e. at the first molar when said tray is placed on the mandibular teeth. The first hinge 6 is advantageously located at the cuspids when said tray is placed on the maxillary teeth. In the closed position of the jaws, the device produces a forced anterior-posterior movement of the mandible, in the direction of arrow F1, with respect to the maxilla during occlusion, which ensures optimal efficacy of the treatment.

In a second embodiment of the device 15 of the invention, and as shown in FIGS. 3b and 4b, the device of the invention is used to correct class III Angle defects. As can better be seen in FIGS. 4 and 5, the hinges 6, 7, 8 are attached close to the respective ends 9, 10, 11, 12 of the rods 3, 4. The second hinge 8 is located close to the end of the first tray 1, i.e. at the first molar when said tray is placed on the maxillary teeth. The first hinge 6 is advantageously located at the cuspids when said tray is placed on the mandibular teeth. In the closed position of the jaws, the device produces a forced anterior-posterior movement of the mandible, in the direction of arrow F2, with respect to the maxilla during occlusion, which ensures optimal efficacy of the treatment.

In a first alternative embodiment, as can better be seen in FIG. 5b, the second rod 4 is made in a single elongate piece having a fixed length, two orifices 19, 20 being provided at its ends to cooperate with the pins of the joints 7 and 8. In this case, a plurality of rods having different lengths are provided so that the rod having a length suitable for the morphology of the person can be chosen.

In a second alternative embodiment, as can better be seen in FIG. 5a, the rod 4 is made in the form of an assembly comprising a slide 17, a sleeve 16 and the tension spring 14. The slide 17 comprises an end having a head 18 with a general dished shape equipped with an end orifice 19 through which the joint pin 8 passes, the opposite end being connected to the tension spring 14. The slide 17 is mounted with the possibility of axial movement inside the sleeve 16. The sleeve 16 comprises an end orifice 20 through which the joint pin 7 passes. The length of the rod 4 is variable and is dependent upon the features of the tension spring 14 chosen. This makes it possible to better adapt the length of the rod 4 to the patient's morphology.

In an alternative embodiment of the rod 3, as can better be seen in FIG. 6, the rod 3 has a variable length. The rod 3 is an assembly comprising a tab 21 equipped with a plurality of orifices 22, uniformly distributed over its length, and an end orifice 26. The tab 21 is mounted to slide in a sheath 23, the latter being equipped with a plurality of orifices 24, evenly spread out along its length, as well as an end orifice 27. The length of the rod 3 is determined on the basis of the patient's morphology, causing the tab 21 to slide inside the sheath 23 and locking it in position with two screws 25 cooperating with two orifices 22 of the tab 21. In another alternative embodiment of the rod 3 (not visible in the drawings), it has a fixed length, and a plurality of rods having different lengths are provided. This makes it possible to better adapt the length of the rod 3 to the patient's morphology, to the defect to be corrected, as well as to the various phases of the treatment.

Rods 3, 4 can be made of any suitable material, and in particular polymer material or a nickel-free stainless steel.

The trays 1, 2 can be made of any suitable material, and in particular polymer material.

In a first embodiment, the device is customized from an impression of the maxillary and mandibular teeth of the patient and by measuring the opening of the oral cavity. The maximum opening of the oral cavity determines the length of the second rod 4 or the shortest rod that reaches a substantially vertical position when the jaws are fully open. The length of the first rod 3 or of the longest rod is determined by the amplitude of the defect to be corrected or the difference in positioning between the upper incisors and the lower incisors.

In a second embodiment, the device is made in fixed sizes, for example in three or four fixed sizes. In an alternative of this embodiment, the trays are made of a thermoformable material, so as to enable the patient, after light heating of the trays (for example by quenching them in hot water), to adapt their shape to that of the teeth, by positioning the trays on the maxillary and mandibular teeth and by closing the jaw so as to enable the trays to best fit the shape of the teeth aligned in the jaws; after cooling of the trays to body temperature, this deformation will become permanent.

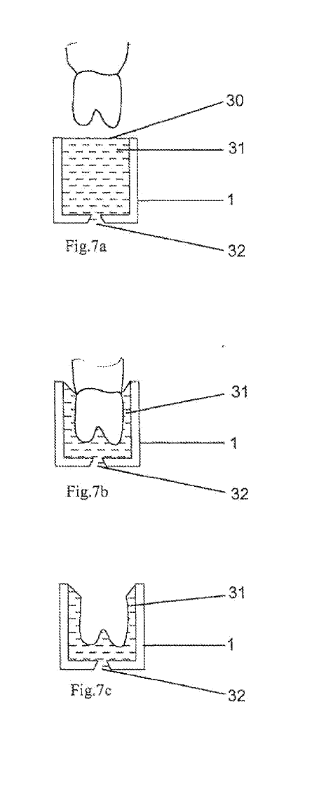

In a third embodiment, the trays are provided in a standard size, but are specifically adapted to the patient. As can better be seen in FIGS. 7a to 7c, the maxillary tray 1 is filled with a liquid, semi-liquid or gelatinous product, such as a polymer gel 31, and comprises, in its upper portion, a thermoformed sheet 30 and, in its lower portion, at least one vent hole 32 (or slot) through which said product can flow. In this embodiment, the maxillary tray, which has been placed on the patient's maxillary teeth, is adapted to the patient's morphology. Thus, in use, the sheet 30 (FIG. 7a) is first removed before use, then the tray is inserted around the teeth of the dental arch (FIG. 7b) so that the excess liquid, semi-liquid or gelatinous polymer product, such as gel 31, can flow through said vent hole 32. Said polymer product is then solidified by a suitable technique, for example by cooling to body temperature, or by polymerization, said polymerization being capable of being induced for example by a chemical initiator that solidifies after a predetermined time, or by a photochemical process. It is possible to use a plurality of vent holes 32, preferably having a conical or flared (reverse taper) shape as shown in FIGS. 7a to 7c. The mandibular tray 2 can be obtained in a manner similar to the maxillary tray 1.

This embodiment makes it possible to obtain a product better suited to the patient's physiology than a standard product, and less expensive than a customized product produced from impressions. In particular, this method makes it possible to conveniently adapt the tray to the patient's jaw in a single treatment session.

In an alternative of the invention, the device is attached to wires that connect rings fastened to the teeth of the maxillary and mandibular arches, respectively.

In another alternative embodiment of the invention (not shown in the figures), the device includes a transverse cylinder secured to the branches of a maxillary tray enabling transverse expansion of the dental arch that it surrounds so as to adapt it to the dimensions of the other dental arch.

Other examples and embodiments of the invention can be envisaged without going beyond the scope of these claims.

1. Device for activating mandibular growth, maxillary growth and mandibular advancement comprising:
a first rod (3) comprising a front end (9) and a rear end;
a second rod (4) comprising a front end (11) and a rear end (12);
said first (3) and second rods (4) being relatively rigid and having different lengths with respect to one another;
a first pivoting joint (6) capable of connecting the front end (9) of the first rod (3) to a first dental arch of a person;
a second pivoting joint (8) capable of connecting the front end of the second rod (4) to the second dental arch of the person;
a third pivoting joint (7) connecting the rear ends (10, 12) of the rods (3, 4) to one another enabling the device to go from an open position to a closed position, and thus to follow the movement of opening and closing of the jaws,
characterized in that said third pivoting joint (7) is capable of being connected to the dental arch supporting the shortest rod with elastic means (5) for returning the device to the closed position so that said rods are capable of causing a relative movement of the mandibular arch with respect to the maxillary arch in the closed position of the jaws.

2. Device according to claim 1, characterized in that the pivot axis of the first pivoting joint (6) is suitable for being located near a cuspid of a dental arch, the pivot axis of the second pivoting joint (8) is suitable for being located near a first molar of the opposite dental arch and the pivot axis of said third pivoting joint (7) is located in an occlusal plane in the closed position of the jaws.

3. Device according to claim 1, characterized in that the second rod (4) is shorter and suitable for having a length substantially equal to the amplitude of opening of the oral cavity measured in the location where the rod (4) is placed.

4. Device according to claim 1, characterized in that the movement of the mandibular arch with respect to the maxillary arch occurs in a substantially horizontal plane in the closed position of the device.

5. Device according to claim 1, characterized in that the ratio of lengths of the two rods (3, 4) is between 0.3 and 0.5.

6. Device according to claim 1, characterized in that the length of at least one of said rods (3, 4) can be adjusted.

7. Device according to claim 1, characterized in that said elastic means (5) include a tension spring (14).

8. Device according to claim 7, characterized in that it includes means for adjusting the force of said tension spring (14).

9. Dental apparatus comprising an upper tray (1) capable of being attached to the maxillary arch, a lower tray (2) capable of being attached to the mandibular arch and a device according to claim 1 connected by the first rod (3) to said upper tray (1) and by the second rod (4) to said lower tray (2).

10. Dental apparatus according to claim 9, characterized in that at least one of the upper (1) or lower trays (2) contains a filling material, preferably at least one liquid, semi-liquid or gelatinous polymer (31) and has one or more vent holes (32) passing through its walls and produced so as to enable the expansion of the tray and the adaptation of the tray to the size of the dental arch that it surrounds after having received said filling material.
